(19) United States
(12) Patent Application Publication
(10) Pub. No.: US 2025/0191574 A1
(43) Pub. Date: Jun. 12, 2025

(54) SPEECH GENERATION BASED ON SPARSE SPEECH-TEXT ALIGNMENT

(71) Applicants: Bytedance Technology Ltd., Grand Cayman (KY); Beijing Youzhuju Network Technology Co., Ltd., Beijing (CN)

(72) Inventors: Yi Ren, Singapore (SG); Chen Zhang, Beijing (CN); Ziyue Jiang, Beijing (CN); Xiang Yin, Beijing (CN)

(21) Appl. No.: 19/048,618

(22) Filed: Feb. 7, 2025

(51) Int. Cl. G10L 13/08; G10L 25/30

(52) U.S. Cl. CPC G10L 13/08; G10L 25/30

(57) ABSTRACT

Embodiments of the disclosure provide a solution for speech generation. A method includes: determining, based on a target text, a plurality of phoneme feature representations corresponding to a sequence of phonemes in the target text and respective phoneme durations for the plurality of phoneme feature representations; extending the plurality of phoneme feature representations based on the respective phoneme durations, to obtain an extended sequence of phoneme feature representations; masking at least one phoneme feature representation in the extended sequence of phoneme feature representations, to obtain a sequence of masked phoneme feature representations; and generating a target speech corresponding to the target text at least based on the sequence of masked phoneme feature representations.

### FIELD

The present disclosure generally relates to computer technologies, and more specifically, to a method, apparatus, device and computer readable storage medium for speech generation.

### BACKGROUND

In recent years, neural codec language models and large-scale diffusion models have brought considerable advancements to the field of speech synthesis. Unlike traditional text-to-speech (TTS) systems, these models are trained on large-scale, multi-domain speech corpora, which contributes to notable improvements in the naturalness and expressiveness of synthesized audio. Given only seconds of speech prompt, these models can synthesize identity-preserving speech in a zero-shot manner. To generate high-quality speech with clear and expressive pronunciation, a TTS model establishes an alignment mapping from text to speech signals. However, from the perspective of speech-text alignment, conventional solutions suffer from issues.

### SUMMARY

In a first aspect of the present disclosure, there is provided a method of speech generation. The method comprises: determining, based on a target text, a plurality of phoneme feature representations corresponding to a sequence of phonemes in the target text and respective phoneme durations for the plurality of phoneme feature representations; extending the plurality of phoneme feature representations based on the respective phoneme durations, to obtain an extended sequence of phoneme feature representations; masking at least one phoneme feature representation in the extended sequence of phoneme feature representations, to obtain a sequence of masked phoneme feature representations; and generating a target speech corresponding to the target text at least based on the sequence of masked phoneme feature representations.

In a second aspect of the present disclosure, there is provided an apparatus for speech generation. The apparatus comprises: a determining module configured to determine, based on a target text, a plurality of phoneme feature representations corresponding to a sequence of phonemes in the target text and respective phoneme durations for the plurality of phoneme feature representations; an extending module configured to extend the plurality of phoneme feature representations based on the respective phoneme durations, to obtain an extended sequence of phoneme feature representations; a masking module configured to mask at least one phoneme feature representation in the extended sequence of phoneme feature representations, to obtain a sequence of masked phoneme feature representations; and a speech generating module configured to generate a target speech corresponding to the target text at least based on the sequence of masked phoneme feature representations.

In a third aspect of the present disclosure, there is provided an electronic device. The electronic device comprises: at least one processor; and at least one memory coupled to the at least one processor and storing instructions executable by the at least one processor, the instructions, upon execution by the at least one processor, causing the electronic device to perform: determining, based on a target text, a plurality of phoneme feature representations corresponding to a sequence of phonemes in the target text and respective phoneme durations for the plurality of phoneme feature representations; extending the plurality of phoneme feature representations based on the respective phoneme durations, to obtain an extended sequence of phoneme feature representations; masking at least one phoneme feature representation in the extended sequence of phoneme feature representations, to obtain a sequence of masked phoneme feature representations; and generating a target speech corresponding to the target text at least based on the sequence of masked phoneme feature representations.

In a fourth aspect of the present disclosure, a computer-readable storage medium is provided. The computer-readable storage medium stores computer executable instructions which, when executed by an electronic device, causes the electronic device perform operations comprising: determining, based on a target text, a plurality of phoneme feature representations corresponding to a sequence of phonemes in the target text and respective phoneme durations for the plurality of phoneme feature representations; extending the plurality of phoneme feature representations based on the respective phoneme durations, to obtain an extended sequence of phoneme feature representations; masking at least one phoneme feature representation in the extended sequence of phoneme feature representations, to obtain a sequence of masked phoneme feature representations; and generating a target speech corresponding to the target text at least based on the sequence of masked phoneme feature representations.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE SEVERAL VIEWS OF THE DRAWINGS

The above and other features, advantages and aspects of the embodiments of the present disclosure will become more apparent in combination with the accompanying drawings and with reference to the following detailed description. In the drawings, the same or similar reference symbols refer to the same or similar elements, where:

FIG. 1 illustrates a schematic diagram of an example environment in which embodiments of the present disclosure may be implemented;

FIG. 2A illustrates a schematic diagram of an inference process of a machine learning model in accordance with some embodiments of the present disclosure;

FIG. 2B illustrates a schematic diagram of a training process of the machine learning model of FIG. 2A in accordance with some embodiments of the present disclosure;

FIG. 3 illustrates a schematic diagram of a training process of an acoustic encoder and an acoustic decoder in accordance with some embodiments of the present disclosure;

FIG. 4 illustrates a flowchart of a process for speech generation in accordance with some embodiments of the present disclosure;

FIG. 5 shows a block diagram of an apparatus for speech generation in accordance with some embodiments of the present disclosure; and

FIG. 6 illustrates a block diagram of an electronic device in which one or more embodiments of the present disclosure can be implemented.

### DETAILED DESCRIPTION

The embodiments of the present disclosure will be described in more detail below with reference to the accompanying drawings. Although some embodiments of the present disclosure are shown in the drawings, it would be appreciated that the present disclosure may be implemented in various forms and should not be interpreted as limited to the embodiments described herein. On the contrary, these embodiments are provided for a more thorough and complete understanding of the present disclosure. It would be appreciated that the drawings and embodiments of the present disclosure are only for the purpose of illustration and are not intended to limit the scope of protection of the present disclosure.

In the description of the embodiments of the present disclosure, the term “including” and similar terms would be appreciated as open inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below. As used herein, the term “model” can represent the matching degree between various data. For example, the above matching degree can be obtained based on various technical solutions currently available and/or to be developed in the future.

It will be appreciated that the data involved in this technical proposal (including but not limited to the data itself, data acquisition or use) shall comply with the requirements of corresponding laws, regulations and relevant provisions.

It will be appreciated that before using the technical solution disclosed in each embodiment of the present disclosure, users should be informed of the type, the scope of use, the use scenario, etc. of the personal information involved in the present disclosure in an appropriate manner in accordance with relevant laws and regulations, and the user's authorization should be obtained.

For example, in response to receiving an active request from a user, a prompt message is sent to the user to explicitly prompt the user that the operation requested operation by the user will need to obtain and use the user's personal information. Thus, users may select whether to provide personal information to the software or the hardware such as an electronic device, an application, a server or a storage medium that perform the operation of the technical solution of the present disclosure according to the prompt information.

As an optional but non-restrictive implementation, in response to receiving the user's active request, the method of sending prompt information to the user may be, for example, a pop-up window in which prompt information may be presented in text. In addition, pop-up windows may also contain selection controls for users to choose “agree” or “disagree” to provide personal information to electronic devices.

It will be appreciated that the above notification and acquisition of user authorization process are only schematic and do not limit the implementations of the present disclosure. Other methods that meet relevant laws and regulations may also be applied to the implementation of the present disclosure.

As used herein, the term “model” can learn a correlation between respective inputs and outputs from training data, so that a corresponding output can be generated for a given input after training is completed. The generation of the model can be based on machine learning techniques. Deep learning is a machine learning algorithm that processes inputs and provides corresponding outputs by using multiple layers of processing units. A neural networks model is an example of a deep learning-based model. As used herein, “model” may also be referred to as “machine learning model”, “learning model”, “machine learning network”, or “learning network”, and these terms are used interchangeably herein.

“Neural networks” are a type of machine learning network based on deep learning. Neural networks are capable of processing inputs and providing corresponding outputs, typically comprising input and output layers and one or more hidden layers between the input and output layers. Neural networks used in deep learning applications typically comprise many hidden layers, thereby increasing the depth of the network. The layers of neural networks are sequentially connected so that the output of the previous layer is provided as input to the latter layer, where the input layer receives the input of the neural network and the output of the output layer serves as the final output of the neural network. Each layer of a neural network comprises one or more nodes (also known as processing nodes or neurons), each of which processes input from the previous layer.

Usually, machine learning can roughly comprise three stages, namely training stage, test stage, and application stage (also known as inference stage). During the training stage, a given model can be trained using a large scale of training data, iteratively updating parameter values until the model can obtain consistent inference from the training data that meets the expected objective. Through the training, the model can be considered to learn the correlation between input and output (also known as input-to-output mapping) from the training data. The parameter values of the trained model are determined. In the test stage, test inputs are applied to the trained model to test whether the model can provide correct outputs, thereby determining the performance of the model. In the application stage, the model can be used to process actual inputs and determine corresponding outputs based on the parameter values obtained from training.

A diffusion model, also known as a diffusion probability model, is a type of generative model. This model generates data by simulating the diffusion process. This process is inspired by physical processes such as thermal diffusion. The diffusion model includes forward diffusion process and reverse diffusion process. The diffusion model simulates a forward diffusion process that gradually adds noise, and then learns how to reverse this process to generate new data samples.

In the forward diffusion process, noise is gradually added to the data, and through a series of steps, the data becomes increasingly random until it resembles pure noise. This process can be seen as a Markov chain, where Gaussian noise is added to the data at each step. The forward diffusion process can be expressed as: q(xₜ|xₜ₋₁)= [symbol] (xₜ;\sqrt{αₜ}xₜ₋₁), (1−αₜ)I), where xₜ is the noise data from step t, αₜ is used to control the amount of added noise. The forward diffusion process is performed during model training, and the data used to add noise is the training sample.

In the reverse diffusion process (or reverse denoising process), the model learns how to reverse the step of adding noise. Starting from pure noise, the diffusion model gradually removes the noise and generates data that matches the training distribution. The reverse diffusion process is typically simulated using a neural network that predicts the noise added at each step: pθ(xₜ₋₁|xₜ)= [symbol] (xₜ₋₁;u_{θ}(xₜ, t), σ_{θ}(xₜ, t), where u_{θ} and σ_{θ} represent learned model parameters. After completing the model training, the model that performs the backpropagation process can first sample from the noise distribution and iteratively denoise using until the desired data is obtained.

In the diffusion model, time step refers to the number of steps in which noise is added during the forward diffusion process. The total number of steps Tis usually a predetermined value, indicating how many steps are required for the transition from raw data to pure noise. At each time step t, Gaussian noise is added to the data according to a predetermined noise scheme, which is continuous and dependent on the results of the previous step.

When generating data, the inference step of the diffusion model refers to the number of steps required to recover the original data from pure noise during the backward diffusion process. The number of reasoning steps directly affects the quality and speed of generating data. The more reasoning steps there are, the higher the quality of the generated data, but at the same time, it also increases computational costs and time. In practical applications, the balance between generation quality and efficiency can be achieved by adjusting the number of inference steps. In some embodiments, the inference steps correspond to time steps, and each inference step may correspond to one or more time steps. For example, if the total time steps of the diffusion model are 1000 steps and the inference steps are set to 50 steps, then each inference step may be considered as corresponding to 20 time steps.

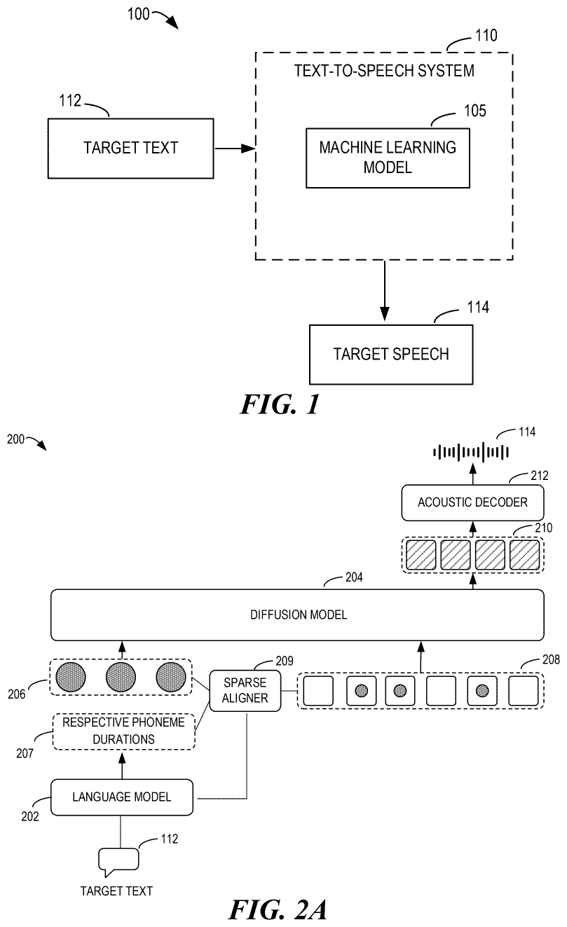

FIG. 1 illustrates a block diagram of an example environment 100 in which various embodiments of the present disclosure may be implemented. In the environment 100 of FIG. 1, a text-to-speech (TTS) system 110 applies a machine learning model 105 to perform speech generation. The machine learning model 105 is configured to generate a target speech 114 corresponding to an input target text 112.

The machine learning model 105 may be configured as any suitable type of models that is capable of generating an audio or a speech. In some embodiments, the machine learning model 105 may be constructed based on a type of generative model. In some examples, the machine learning model 105 may be constructed based on a diffusion model.

In FIG. 1, the TTS system 110 may be implemented at any computing system with computing capability, such as various computing devices/systems, terminal devices, servers, etc. Terminal devices may include any type of mobile terminals, fixed terminals, or portable terminals, including mobile phones, desktop computers, laptops, netbooks, tablets, media computers, multimedia tablets, or any combination of the aforementioned, including accessories and peripherals of these devices or any combination thereof. Servers include but are not limited to mainframe, edge computing nodes, computing devices in cloud environment, etc.

It should be understood that the structure and function of each element in the environment 100 is described for illustrative purposes only and does not imply any limitations on the scope of the present disclosure.

As briefly mentioned above, conventional solutions for speech-text alignment suffer from some issues. The following will describe some conventional solutions for speech-text alignment and their related issues. Autoregressive codec language models (AR LM) are configured to achieve the alignment paths through attention mechanisms in their time-autoregressive generation processes. However, the lengthy discrete speech codes, which typically require a minimum bit rate of 1.5 kbps, impose a significant burden on these autoregressive language models. Therefore, these models are inefficient and robustness.

Diffusion models without predefined alignments (referred to as diffusion without PA) require substantial parameters. Recent diffusion-based TTS works demonstrate that non-autoregressive diffusion models can effectively perform text-to-speech synthesis without the need for explicit duration modeling, which significantly speeds up the speech generation process. However, these algorithms require a significant portion of parameters to establish the text-to-speech alignment. Besides, these solutions cannot provide fine-grained control over the duration of specific pronunciations and can only adjust the overall speech rate.

Predefined alignment-based diffusion models (referred to as diffusion with PA) have limited expressiveness and a complex inference process. During training, alignment paths are directly introduced into their models to reduce the complexity of text-to-speech generation, which achieves higher intelligibility and similarity. Nevertheless, they suffer from the following two limitations. The first limitation is that predefined alignments constrain the model's ability to produce expressive and natural-sounding speech. The second limitation is that an external alignment tool is required in inference to obtain the duration prompt, which is time-consuming and complicates the overall pipeline.

In some related works, zero-shot TTS aims to synthesize unseen voices with speech prompts. Among them, neural codec language models first can autoregressively synthesize speech that rivals human recordings in naturalness and expressiveness. However, they still face several challenges, such as the lossy compression in discrete audio tokenization and the time-consuming nature of autoregressive generation. To address these issues, some subsequent works explore solutions based on continuous vectors and non-autoregressive diffusion models. These works can be categorized into two main types. The first type directly models speech-text alignments using attention mechanisms without explicit duration modeling. Although these models perform well in terms of generation speed and quality, they typically require a large number of parameters to learn speech-text alignments. The second type utilizes predefined alignments to simplify alignment learning. However, the expressiveness of these models is limited by predefined alignments and the inference pipeline is quite complex.

Embodiments of the present disclosure propose an improved solution of speech generation. In this solution, a plurality of phoneme feature representations corresponding to a sequence of phonemes in a target text and respective phoneme durations for the plurality of phoneme feature representations are determined based on the target text. The plurality of phoneme feature representations are extended based on the respective phoneme durations, to obtain an extended sequence of phoneme feature representations. At least one phoneme feature representation in the extended sequence of phoneme feature representations is masked, to obtain a sequence of masked phoneme feature representations. A target speech corresponding to the target text is generated based on the sequence of masked phoneme feature representations.

With these embodiments of the present disclosure, at least one phoneme feature representation in the extended sequence of phoneme feature representations is masked to enable sparse alignment between the target text and the target speech. In this way, the difficulty of alignment learning may be reduced without limiting the expressiveness of a text-to-speech model and fine-grained control over the duration of each phoneme may be enabled.

Example embodiments of the present disclosure will be described with reference to the drawings.

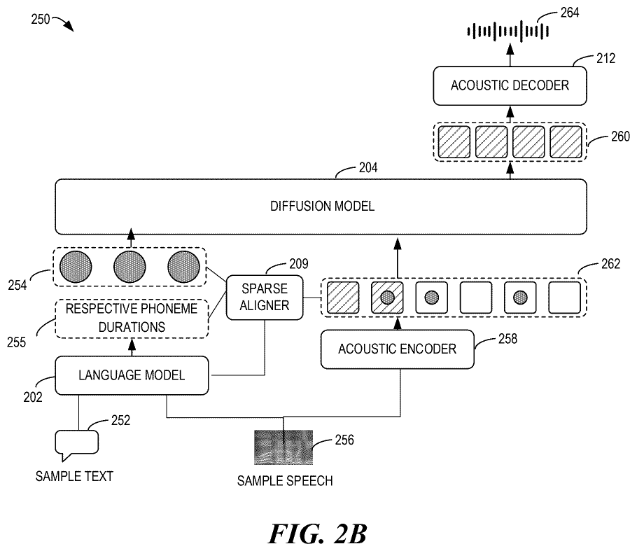

FIG. 2A illustrates a schematic diagram of an inference process 200 of the machine learning model 105 in accordance with some embodiments of the present disclosure. As shown, in the example embodiments of the present disclosure, the machine learning model 105 may be constructed to include a language model 202 and a diffusion model 204.

In some embodiments, the diffusion model 204 may include one or more diffusion transformer blocks, or may be constructed with other diffusion model structure. In some embodiments, the language model 202 may perform a plurality of tasks to obtain one or more types of information required for speech generation. In an example, the language model 202 may take a text as input, and generate a plurality of phonemes for the text and durations of respective phonemes. In some embodiments, the diffusion model 204 may take the phonemes and the durations of respective phonemes of the text as input and then generate a speech corresponding to the text.

As shown in FIG. 2A, a plurality of phoneme feature representations 206 (also referred to as text tokens) corresponding to a sequence of phonemes in a target text 112 and respective phoneme durations 207 for the plurality of phoneme feature representations 206 are determined based on the target text 112. In some embodiments, the plurality of phoneme feature representations 206 and respective phoneme durations 207 may be determined using the language model 202, with the target text 112 as a model input.

In some examples, the plurality of phoneme feature representations 206 may be denoted as p=[p₁, p₂, . . . , pₘ] and respective phoneme durations (also referred to as phoneme duration sequence) may be denoted as d=[d₁, d₂, . . . , dₘ] where m represents the length of the corresponding sequence. The length of a speech vector that corresponds to a phoneme pᵢ is the duration dᵢ.

In the example of FIG. 2A, the target text 112 may be given by a user who wishes to convert a written text (e.g., the target text 112) into a spoken speech or may be obtained from any other suitable sources. The language model 202 may be configured to perform a plurality of tasks for speech processing, such as generating phonemes for a text and predicting durations of each phoneme. In an example, the language model 202 may take a feature representation related to the target text 112 as input and generate a plurality of phoneme feature representations 206 corresponding to a sequence of phonemes in the target text 112 and respective phoneme durations 207 for the plurality of phoneme feature representations 206. A phoneme feature representation in the plurality of phoneme feature representations 206 characterizes a phoneme in the target text 112. A phoneme duration for a phoneme indicates an acoustic duration of the phoneme, which may sometimes be represented as a number of audio frames.

After determining the plurality of phoneme feature representations 206 and the respective phoneme durations 207, a sparse aligner 209 may perform speech-text alignment. Speech-text alignment refers to adjusting the length of each phoneme feature representation in the plurality of phoneme feature representations 206 based on the corresponding phoneme duration. For example, if the duration corresponding to a phoneme p₁ is 2 (e.g., lasting 2 audio frames), then p₁ may be repeated twice so that the length of p₁ may be generated as two audio frames in the resulting speech.

In order to better illustrate embodiments of the present disclosure, reasons behind the characteristics of different speech-text alignment modeling methods in depth. “Diffusion without PA” requires more parameters due to the difficulty in end-to-end modeling of speech-text alignment non-autoregressively. On the other hand, the use of predefined hard alignment paths limits the model's expressiveness and increases the complexity of the pipeline. The characteristics of these systems motivate the inventor of the present disclosure to design an approach that combines the advantages of both. Therefore, a rough speech-text alignment (sometimes referred to as sparse speech-text alignment) instead of the hard speech-text alignment may be provided.

To provide the rough speech-text alignment, in the example embodiments of the present disclosure the plurality of phoneme feature representations 206 are extended based on the respective phoneme durations 207, to obtain an extended sequence of phoneme feature representations. In some embodiments, the length of the extended sequence of phoneme feature representations may be directly proportional to the respective phoneme durations. In the example of FIG. 2A, the sparse aligner 209 may extend take the plurality of phoneme feature representations 206 and the respective phoneme durations 207 as input, and generate the extended sequence of phoneme feature representations.

In some embodiments, for a phoneme feature representation in the plurality of phoneme feature representations 206, the phoneme feature representation may be repeated based on the number of repetitions indicated by a phoneme duration corresponding to the phoneme feature representation. Respective repeated phoneme feature representations for the plurality of phoneme feature representations 206 may be concatenated in an order of the plurality of phoneme feature representations 206, to obtain the extended sequence of phoneme feature representations. In an example, given p=[p₁, p₂, p₃] and d=[2,2,3], p₁ and p₂ may be repeated twice, and p₃ may be repeated three times according to the correspondence between p (i.e., the plurality of phoneme feature representations 206) and d (i.e., respective phoneme durations 207). Then, respective repeated phoneme feature representations for p₁, p₂, p₃ may be concatenated in the order of p₁, p₂, p₃, to obtain the extended sequence of phoneme feature representations, which may be denoted as a=[p₁, p₁, p₂, p₂, p₃, p₃, p₃].

After the plurality of phoneme feature representations 206 are extended, at least one phoneme feature representation in the extended sequence of phoneme feature representations is masked, to obtain a sequence of masked phoneme feature representations 208. In some examples, the extended sequence of phoneme feature representations may be randomly masked.

In some embodiments, for a phoneme feature representation in the plurality of phoneme feature representations 206, one or more of repeated phoneme feature representations for the phoneme feature representation in the extended sequence of phoneme feature representations may be masked by the sparse aligner 209, to retain one of the repeated phoneme feature representations for the phoneme feature representation. That is, among the repeated phoneme feature representations for one phoneme, one phoneme feature representation is retained and the remaining one(s) may be masked.

For example, the plurality of phoneme feature representations 206 may include p₁, p₂ p₃ and extended sequence of phoneme feature representations may be denoted as a=[p₁, p₁, p₂, p₂, p₃, p₃, p₃]. As a result, one or more of repeated phoneme feature representations (i.e., p₁, p₁, p₂, p₂ and p₃, p₃, p₃) for the phoneme feature representation in the extended sequence of phoneme feature representations may be masked by the sparse aligner 209, to retain one of the repeated phoneme feature representations for the phoneme feature representation. In other words, only one anchor for each phoneme feature representation (i.e., p₁, p₂ and p₃) in the extended sequence of phoneme feature representations may be retained. For example, the sequence of masked phoneme feature representations 208 (also referred to as rough speech-text alignment) may be represented as ã=[M, p₁, p₂, M, M, M, p₃], where M represents a masked token (also referred to as a masked vector), p₁, p₂ and p₃ represents the anchor for each phoneme feature representation. It is to be noted that the above method for providing the rough alignment is merely an example and there may be other appropriate methods for providing the rough alignment. In this way, the rough alignment information does not limit expressiveness of a generated speech and also enables fine-grained control over each phoneme duration.

After the sequence of masked phoneme feature representations 208 is obtained, a target speech 114 corresponding to the target text 112 is generated at least based on the sequence of masked phoneme feature representations 208, using the diffusion model 204.

In some embodiments, the diffusion model 204 may generate a target speech feature representation 210 (also referred to as speech latent vector) at least based on the sequence of masked phoneme feature representations 208. Then, an acoustic decoder 212 may decode the target speech feature representation 210 into the target speech 114. In some embodiments, the acoustic decoder 212 may include a wave decoder, which is configured to process the input speech latent vector corresponding to a speech and generate an acoustic wave corresponding to the speech.

In some embodiments, the diffusion model 204 may be configured to predict a speech that matches the style of a given speaker and the content of a provided text through a diffusion procedure. In some embodiments, to improve model efficiency, the diffusion model 204 may be operated based on a rectified flow procedure. The rectified flow procedure is introduced below simply.

Given the random variables Z₀ sampled from a standard Gaussian distribution π₀ and Z₁ sampled from the latent space c given by a speech compression model (also referred to an acoustic encoder, configured to encode a speech into a latent vector) with data density π₁, the rectified flow may be adopted to implicitly learn the transport map T, which yields Z₁:=T(Z₀). The rectified flow learns T by constructing the following ordinary differential equation (ODE):

$$d {Z}_{t} = v ( {Z}_{t} , t ) dt , \qquad ( 1 )$$

where t∈[0,1] denotes a time step sampled from 0 to 1, and v denotes the drift force. Eq. (1) converts Z₀ from π₀ to Z₁ from π₁. The drift force v drives the flow to follow the direction (Z₁−Z₀). In the scenario for speech generation, Z₁ represents the sample speech. The diffusion model 204, parameterized by θ, can be trained by estimating v(Zₜ, t) with v_{θ}(Zₜ, t) through minimizing the least squares loss with respect to the line directions (Z₁−Z₀), which may be represented as follows:

$${min}_{v} {\int }_{0}^{1} 𝔼 [ {‖ ( {Z}_{1} - {Z}_{0} ) - v ( {Z}_{t} , t ) ‖}^{2} ] dt . \qquad ( 2 )$$

In some embodiments, standard transformer blocks may be used as the basic structure for the diffusion model 204 and the rotary position embedding (RoPE) may be adopted as the positional embedding. During training, the latent vector sequence may be randomly divided into a prompt region zₚᵣₒₘₚₜ and a target region z_{target}, with the proportion of zₚᵣₒₘₚₜ being γ˜U(0.1,0.9). This means that when the longest speech length during training is 60 seconds, the model can generate 54 seconds of target speech using just a 6-second prompt, which is sufficient to cover most speech synthesis scenarios. v_{θ} may be used to predict the masked target vector \hat{z}_{target} conditioned on zₚᵣₒₘₚₜ and the phoneme embedding p, denoted as v_{θ}(\hat{Z}_{target}|zₚᵣₒₘₚₜ, p). The loss is calculated using only z_{target}. The latent diffusion transformer learns the average pronunciation from p and the specific characteristics such as timbre, accent, and prosody of the corresponding speaker from zₚᵣₒₘₚₜ.

In some embodiments, the target speech 114 may further be generated on a further condition of a prompt speech of a target speaker (not shown in FIG. 2A). With a conditional generation procedure based on the prompt speech, the generated target speech 114 may be generated with the speaking style of the target speaker in the prompt speech. For example, the speaking style may include timbre, acoustic pattern, accent of the target speaker. Specifically, an acoustic prompt feature representation (also referred to as latent speech vector sequence) may be extracted from the prompt speech and the target speech 114 may be generated based on the sequence of masked phoneme feature representations 208 and the acoustic prompt feature representation. In some examples, the acoustic prompt feature representation may include a timbre feature representation characterizing timbre represented in the prompt speech and a prosody feature representation characterizing a prosodic pattern represented in the prompt speech. In some examples, the latent speech vector sequence may be denoted as z=[z₁, Z₂, . . . , zₙ], where m represent the length of the sequence.

In some embodiments, an acoustic encoder (not shown in FIG. 2A) may encode the prompt speech into the acoustic prompt feature representation. The acoustic prompt feature representation may be combined with the sequence of masked phoneme feature representations 208. Then, the diffusion model 204 may take the combined sequence as input and generate the target speech feature representation 210. The acoustic decoder 212 may decode the target speech feature representation 210 into the target speech 114 which may have the speaking style of the target speaker.

In some embodiments, classifier-free guidance approach may be employed to steer the output of the diffusion model 204 (denoted as g_{θ}) towards the conditional generation g_{θ}(zₜ, c) and away from the unconditional generation g_{θ}(zₜ, ø), which may be presented as follows:

$${\hat{g}}_{θ} ( {z}_{t} , c ) = {g}_{θ} ( {z}_{t} , ⌀ ) + α \cdot [ {g}_{θ} ( {z}_{t} , c ) - {g}_{θ} ( {z}_{t} , ⌀ ) ] \qquad ( 3 )$$

where zₜ represents an intermediate feature representation for generating the target speech 114 of the diffusion model 204 at time t, c denotes a conditional state, ø denotes an unconditional state, and a denotes a guidance scale. In some examples, z₀ represents a noise sampled from a Gaussian distribution.

In some embodiments, the conditional state may include a condition of the plurality of phoneme feature representations (also referred to as phoneme embeddings) and a condition of the acoustic prompt feature representation of the prompt feature (also referred to as speaker prompt). First intermediate speech feature representation may be generated without condition information. Second intermediate speech feature representation may be generated with the condition of the plurality of phoneme feature representations. Third intermediate speech feature representation may be generated with the condition of the plurality of phoneme feature representations and the condition of the acoustic prompt feature representation of the prompt feature.

In some embodiments, to determine the target speech 114, a first difference between the third intermediate speech feature representation and the second intermediate speech feature representation may be considered as text guidance for the generation of the target speech, and a second difference between the second intermediate speech feature representation and the first intermediate speech feature representation may be considered as speaker guidance for the generation of the target speech. A weighted sum of the first difference and the second difference may be determined with a predetermined text guidance scale corresponding to the first difference and a predetermined speaker guidance scale corresponding to the second difference. Then, the target speech 114 may be determined based on a sum of the weighted sum and the first intermediate speech feature representation.

In some examples, multi-condition classifier-free guidance technique may be adopted to generate the target speech 114, which may be represented as follows:

$${\hat{g}}_{θ} ( {z}_{t} , p , {z}_{prompt} ) = {α}_{s p k} [ {g}_{θ} ( {z}_{t} , p , {z}_{p r ompt} ) - {g}_{θ} ( {z}_{t} , p , ⌀ ) ] + {α}_{txt} [ {g}_{θ} ( {z}_{t} , p , ⌀ ) - {g}_{θ} ( {z}_{t} , ⌀ , ⌀ ) ] + {g}_{θ} ( {z}_{t} , ⌀ , ⌀ ) \qquad ( 4 )$$

where p represents the condition of the plurality of phoneme feature representations, zₚᵣₒₘₚₜ represents the condition of the acoustic prompt feature representation of the prompt feature, g_{θ}(zₜ, ø, ø) represents the first intermediate speech feature representation generated by the diffusion model without condition, g_{θ}(zₜ, p, ø) represents the second intermediate speech feature representation generated by the diffusion model with the condition p, g_{θ}(zₜ, p, zₚᵣₒₘₚₜ) represents the third intermediate speech feature representation generated by the diffusion model with the conditions p and zₚᵣₒₘₚₜ, αₜₓₜ represents the predetermined text guidance scale and αₛₚₖ represents the predetermined speaker guidance scale.

In Eq. (4), the text guidance scale αₜₓₜ may be used to control the accent intensity and the speaker guidance scale αₛₚₖ may be a relatively high value to ensure a high speaker similarity. In the experiments, as the text guidance scale increases, it is observed that the pronunciation changes according to the following pattern. Firstly, the pronunciation starts with improper pronunciation, then shifts to pronouncing with the current speaker's accent and finally approaches the standard pronunciation of the target language. In this way, higher generation quality and more flexible control may be achieved. Furthermore, the text guidance scale can also be used to modulate the intensity of personal accents, offering a new direction for enhancing speech expressiveness.

After the inference process 200 is described, a training process of the machine learning model 105 may be illustrated with reference to FIG. 2B, which illustrates a schematic diagram of a training process 250 of the machine learning model 105 in accordance with some embodiments of the present disclosure. As shown in FIG. 2B, a plurality of sample phoneme feature representations 254 corresponding to a sequence of sample phonemes in a sample text 252 and respective sample phoneme durations 255 for the plurality of sample phoneme feature representations 254 may be determined based on the sample text 252 and a sample speech 256 (sometimes referred to as first sample speech) using the language model 202. Then, a first speech feature representation may be determined based on the sample speech 256 using a trained acoustic encoder 258.

In some embodiments, the plurality of sample phoneme feature representations may be extended based on the respective sample phoneme durations, to obtain an extended sequence of sample phoneme feature representations. The at least one phoneme feature representation in the extended sequence of sample phoneme feature representations may be masked by the sparse aligner 209, to obtain a sequence of masked sample phoneme feature representations. The detailed process of extending the plurality of sample phoneme feature representations and masking at least one phoneme feature representation may be referred to process 200, which is not elaborated here.

After the sequence of masked sample phoneme feature representations and first sample speech are obtained, a reconstructed speech feature representation 260 may be determined based on the sequence of masked sample phoneme feature representations and the first speech feature representation (i.e., a combination 262 of the sequence of masked sample phoneme feature representations and the first speech feature representation) using the diffusion model 204 under training. A reconstructed speech 264 may be generated based on a reconstructed speech feature representation 260 using a trained acoustic decoder 212. Then, the diffusion model 204 may be trained based on a difference between the sample speech 256 and the reconstructed speech 264. In some examples, the diffusion model 204 may be trained based on a training objective, which is configured to reduce or minimize the difference between the first sample speech 256 and the reconstructed speech 264.

In some embodiments, the diffusion model 204 may be trained with different sub-training samples. Firstly, training samples with a plurality of conditions may be obtained. The plurality of conditions at least includes a first condition indicating the plurality of sample phoneme feature representations and a second condition indicating the first sample speech. A first sub-training sample may be selected from the training samples with the second condition being dropped. A second sub-training sample may be selected from the first sub training sample with the first condition being dropped. A third sub-training sample may be determined by removing the first sub training sample from the training samples. Then, the diffusion model 204 may be trained based on the first sub-training sample, the second sub-training sample and the third sub-training sample. In some examples, condition zₚᵣₒₘₚₜ (as an example of the second condition) may be randomly dropped with a probability of pₛₚₖ. Only when zₚᵣₒₘₚₜ is dropped, condition p (as an example of the first condition) may be randomly dropped with a probability of 50%. In this way, under the training of different sub-training samples, the diffusion model 204 can handle all three types of conditional inputs described in Eq. (4).

In some embodiments, the diffusion model 204 may be trained by piecewise rectified flow acceleration. Although the diffusion model 204 is non-autoregressive in terms of the time dimension, it requires multiple iterations to solve the rectified flow ODE. The number of iterations (i.e., the number of function evaluations, NFE) has a great impact on inference efficiency, especially when the model scales up further. Therefore, the Piecewise Rectified Flow (PeRFlow) technique may be adopted to further reduce NFE by segmenting the flow trajectories into multiple time windows. Applying reflow operations within these shortened time intervals, PeRFlow eliminates the need to simulate the full ODE trajectory for training data preparation, allowing it to be trained in real-time alongside large-scale real data during the training process.

Given the number of windows K, the time t∈[0,1] may be divided into K time windows {(tₖ₋₁, tₖ]}ₖ₌₁^{K}. Then, k∈{1, . . . , K} may be sample uniformly. The start point of the sampled time window zₜ_{ₖ₋₁}=\sqrt{1−ρ²(tₖ₋₁)}z₁+σ(tₖ₋₁)ϵ may be used to solve the endpoint of the time window \hat{z}ₜ_{ₖ}=ϕ_{θ}(zₜ_{ₖ₋₁}, tₖ₋₁, tₖ), where ε˜ [symbol] (0, I) represents the random noise, σ(t) represents the noise schedule, and de represents the ODE solver of a teacher model. Since zₜ_{ₖ₋₁} and \hat{z}ₜ_{ₖ} are available, the student model \hat{θ} may be trained via the following loss objectives:

$$ℓ = {‖ {v}_{\hat{θ}} ( {z}_{t} , t ) - \frac{{\hat{z}}_{{t}_{k}} - {z}_{{t}_{k - 1}}}{{t}_{k} - {t}_{k - 1}} ‖}^{2} \qquad ( 5 )$$

where v_{\hat{θ}} represents the estimated drift force with parameter \hat{θ} and t is uniformly sampled from (tₖ₋₁, tₖ]. In this way, inference steps of the diffusion model 204 may be reduced, thereby achieving highly efficient zero-shot TTS with minimal quality degradation.

In some embodiments, the acoustic encoder 258 and the acoustic decoder 212 may be trained separately from the training of the diffusion model 204 (e.g., trained before the diffusion model 204). In some examples, the acoustic decoder 212 may be a generative adversarial networks (GAN)-based decoder, which is configured to generate a sound wave based on a speech feature representation (also referred to as speech latent vector).

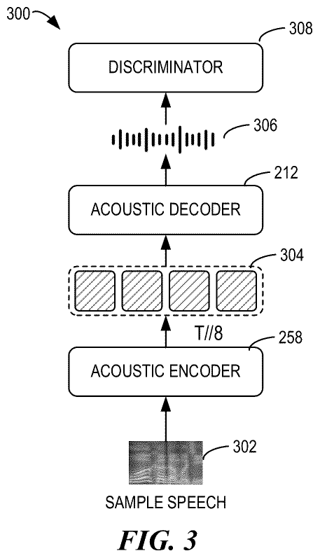

An example training process of the acoustic encoder 258 and the acoustic decoder 212 may be illustrated with reference to FIG. 3, which illustrates a schematic diagram of a training process 300 of the acoustic encoder 258 and the acoustic decoder 212 in accordance with some embodiments of the present disclosure. As shown in FIG. 3, a second speech feature representation 304 may be determined based on a sample speech 302 (sometimes referred to as second sample speech) using the acoustic encoder 258. A reconstructed acoustic wave 306 may be generated based on the second speech feature representation 304 using the acoustic decoder 212 under training. In some examples, given a speech spectrogram s∈ [symbol] ^{T×C} (as an example of the second sample speech 302), the acoustic encoder 258 may encode s into a latent vector z (as an example of the second speech feature representation 304). The acoustic decoder 212 reconstructs the waveform (e.g., the reconstructed acoustic wave 306), which may be represented as x=D(z)=D(E(s)), where T is the time dimension and C is the frequency dimension. To reduce the computational burden of the model and simplify speech-text alignment learning, the encoder E downsamples the spectrogram by a factor of d=8 in length.

After the reconstructed acoustic wave 306 is generated, the acoustic encoder 258 and the acoustic decoder 212 may be trained based on a difference between the reconstructed acoustic wave 306 and an acoustic wave corresponding to the sample speech 302. In some examples, the acoustic encoder 258 and the acoustic decoder 212 may be trained may be trained based on a training objective, which is configured to reduce or minimize the difference between the reconstructed acoustic wave 306 and an acoustic wave corresponding to the second sample speech 302.

In some embodiments, the training loss of the acoustic encoder 258 and the acoustic decoder 212 may be formulated as [symbol] = [symbol] _{rec}+ [symbol] _{KL}+ [symbol] _{Adv}, where [symbol] _{rec}=∥s−ŝ∥² represents the spectrogram reconstruction loss between the reconstructed acoustic wave 306 and the acoustic wave corresponding to the sample speech 302, [symbol] _{KL} represents the slight KL-penalty loss, and [symbol] _{Adv} represents the least squares generative adversarial networks (LSGAN)-styled adversarial loss. In this way, after training, a one-second speech clip can be encoded into 12.5 vector frames.

In some embodiments, a discriminator 308 such as a multi-period discriminator (MPD), multi-scale discriminator (MSD), and multi-resolution discriminator (MRD) may be adopted. The discriminator 308 may be configured to determine whether the reconstructed acoustic wave 306 is real data or data jointly generated by the acoustic encoder 258 and the acoustic decoder 212. In some examples, the discriminator 308 may take the reconstructed acoustic wave 306 as input and generate a scalar indicating a probability of whether the reconstructed acoustic wave 306 is real data. In this way, the high-frequency details in waveforms may be modeled, which ensure perceptually high-quality reconstructions.

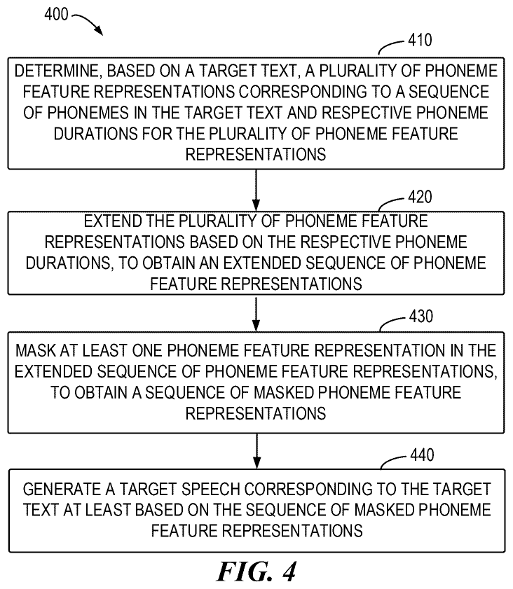

FIG. 4 illustrates a flowchart of a process 400 for speech generation in accordance with some embodiments of the present disclosure. The process 400 may be implemented at the TTS system 110 of FIG. 1.

At block 410, the TTS system 110 determines, based on a target text, a plurality of phoneme feature representations corresponding to a sequence of phonemes in the target text and respective phoneme durations for the plurality of phoneme feature representations.

At block 420, the TTS system 110 extends the plurality of phoneme feature representations based on the respective phoneme durations, to obtain an extended sequence of phoneme feature representations.

At block 430, the TTS system 110 masks at least one phoneme feature representation in the extended sequence of phoneme feature representations, to obtain a sequence of masked phoneme feature representations.

At block 440, the TTS system 110 generates a target speech corresponding to the target text at least based on the sequence of masked phoneme feature representations.

In some embodiments, extending the plurality of phoneme feature representations, to obtain the extended sequence of phoneme feature representations comprises: for a phoneme feature representation in the plurality of phoneme feature representations, repeating the phoneme feature representation based on the number of repetitions indicated by a phoneme duration corresponding to the phoneme feature representation; and concatenating respective repeated phoneme feature representations for the plurality of phoneme feature representations in an order of the plurality of phoneme feature representations, to obtain the extended sequence of phoneme feature representations.

In some embodiments, masking the at least one phoneme feature representation in the extended sequence of phoneme feature representations comprises: for a phoneme feature representation in the plurality of phoneme feature representations, masking one or more of repeated phoneme feature representations for the phoneme feature representation in the extended sequence of phoneme feature representations, to retain one of the repeated phoneme feature representations for the phoneme feature representation.

In some embodiments, generating the target speech further comprises: extracting an acoustic prompt feature representation from a prompt speech of a target speaker; and generating the target speech based on the sequence of masked phoneme feature representations and the acoustic prompt feature representation.

In some embodiments, generating the target speech based on the sequence of masked phoneme feature representations and the acoustic prompt feature representation comprises: generating a first intermediate speech feature representation without condition information; generating a second intermediate speech feature representation with a condition of the plurality of phoneme feature representations; generating a third intermediate speech feature representation with a condition of the plurality of phoneme feature representations and a condition of the acoustic prompt feature representation of the prompt feature; and determining the target speech based on the first intermediate speech feature representation, the second intermediate speech feature representation and the third intermediate speech feature representation.

In some embodiments, the target speech is generated at least based on the sequence of masked phoneme feature representations using a trained diffusion model, and wherein the diffusion model is trained at least by: determining, using a language model, a plurality of sample phoneme feature representations corresponding to a sequence of sample phonemes in a sample text and respective sample phoneme durations for the plurality of sample phoneme feature representations based on the sample text and a first sample speech; determining, using a trained acoustic encoder, a first speech feature representation based on the first sample speech; extending the plurality of sample phoneme feature representations based on the respective sample phoneme durations, to obtain an extended sequence of sample phoneme feature representations; masking at least one phoneme feature representation in the extended sequence of sample phoneme feature representations, to obtain a sequence of masked sample phoneme feature representations; determining, using the diffusion model under training, a reconstructed speech feature representation based on the sequence of masked sample phoneme feature representations and the first speech feature representation; generating, using a trained acoustic decoder, a reconstructed speech for the first sample speech based on the reconstructed speech feature representation; and training the diffusion model based on a difference between the first sample speech and the reconstructed speech.

In some embodiments, the diffusion model is further trained by: obtaining training samples with a plurality of conditions, the plurality of conditions at least comprising a first condition indicating the plurality of sample phoneme feature representations and a second condition indicating the first sample speech; selecting a first sub-training sample from the training samples with the second condition being dropped; selecting a second sub-training sample from the first sub training sample with the first condition being dropped; determining a third sub-training sample by removing the first sub training sample from the training samples; and training the diffusion model based on the first sub-training sample, the second sub-training sample and the third sub-training sample.

In some embodiments, the diffusion model is trained by piecewise rectified flow acceleration.

In some embodiments, the acoustic encoder and the acoustic decoder are trained by: determining, using the acoustic encoder under training, a second speech feature representation based on a second sample speech; generating, using the acoustic decoder under training, a reconstructed acoustic wave based on the second speech feature representation; and training the acoustic encoder and the acoustic decoder based on a difference between the reconstructed acoustic wave and an acoustic wave corresponding to the second sample speech.

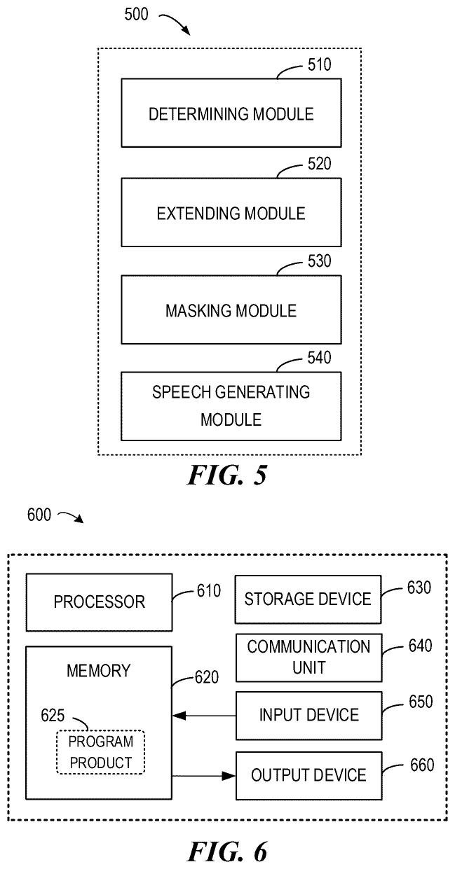

FIG. 5 shows a block diagram of an apparatus 500 for speech generation in accordance with some embodiments of the present disclosure. The apparatus 500 may be implemented, for example, or included at the TTS system 110 of FIG. 1. Various modules/components in the apparatus 500 may be implemented by hardware, software, firmware, or any combination thereof.

As shown, the apparatus 500 includes a determining module 510 configured to determine, based on a target text, a plurality of phoneme feature representations corresponding to a sequence of phonemes in the target text and respective phoneme durations for the plurality of phoneme feature representations.

The apparatus 500 includes an extending module 520 configured to extend the plurality of phoneme feature representations based on the respective phoneme durations, to obtain an extended sequence of phoneme feature representations.

The apparatus 500 includes a masking module 530 configured to mask at least one phoneme feature representation in the extended sequence of phoneme feature representations, to obtain a sequence of masked phoneme feature representations.

The apparatus 500 further includes a speech generating module 540 configured to generate a target speech corresponding to the target text at least based on the sequence of masked phoneme feature representations.

In some embodiments, the extending module 520 is further configured to, for a phoneme feature representation in the plurality of phoneme feature representations, repeat the phoneme feature representation based on the number of repetitions indicated by a phoneme duration corresponding to the phoneme feature representation; and concatenate respective repeated phoneme feature representations for the plurality of phoneme feature representations in an order of the plurality of phoneme feature representations, to obtain the extended sequence of phoneme feature representations

In some embodiments, the masking module 530 is further configured to, for a phoneme feature representation in the plurality of phoneme feature representations, mask one or more of repeated phoneme feature representations for the phoneme feature representation in the extended sequence of phoneme feature representations, to retain one of the repeated phoneme feature representations for the phoneme feature representation.

In some embodiments, the speech generating module 540 is further configured to extract an acoustic prompt feature representation from a prompt speech of a target speaker; and generate the target speech based on the sequence of masked phoneme feature representations and the acoustic prompt feature representation.

In some embodiments, the speech generating module 540 is further configured to generate a first intermediate speech feature representation without condition information; generate a second intermediate speech feature representation with a condition of the plurality of phoneme feature representations; generate a third intermediate speech feature representation with a condition of the plurality of phoneme feature representations and a condition of the acoustic prompt feature representation of the prompt feature; and determine the target speech based on the first intermediate speech feature representation, the second intermediate speech feature representation and the third intermediate speech feature representation.

In some embodiments, the target speech is generated at least based on the sequence of masked phoneme feature representations using a trained diffusion model and the apparatus 500 further includes a first training module configured to determine, using a language model, a plurality of sample phoneme feature representations corresponding to a sequence of sample phonemes in a sample text and respective sample phoneme durations for the plurality of sample phoneme feature representations based on the sample text and a first sample speech; determine, using a trained acoustic encoder, a first speech feature representation based on the first sample speech; extend the plurality of sample phoneme feature representations based on the respective sample phoneme durations, to obtain an extended sequence of sample phoneme feature representations; mask at least one phoneme feature representation in the extended sequence of sample phoneme feature representations, to obtain a sequence of masked sample phoneme feature representations; determine, using the diffusion model under training, a reconstructed speech feature representation based on the sequence of masked sample phoneme feature representations and the first speech feature representation; generate, using a trained acoustic decoder, a reconstructed speech for the first sample speech based on the reconstructed speech feature representation; and train the diffusion model based on a difference between the first sample speech and the reconstructed speech.

In some embodiments, the first training module is further configured to obtain training samples with a plurality of conditions, the plurality of conditions at least comprising a first condition indicating the plurality of sample phoneme feature representations and a second condition indicating the first sample speech; select a first sub-training sample from the training samples with the second condition being dropped; select a second sub-training sample from the first sub training sample with the first condition being dropped; determining a third sub-training sample by removing the first sub training sample from the training samples; and train the diffusion model based on the first sub-training sample, the second sub-training sample and the third sub-training sample.

In some embodiments, the diffusion model is trained by piecewise rectified flow acceleration.

In some embodiments, the apparatus 500 further includes a second training module configured to determine, using the acoustic encoder under training, a second speech feature representation based on a second sample speech; generate, using the acoustic decoder under training, a reconstructed acoustic wave based on the second speech feature representation; and train the acoustic encoder and the acoustic decoder based on a difference between the reconstructed acoustic wave and an acoustic wave corresponding to the second sample speech.

FIG. 6 illustrates a block diagram of an electronic device 600 in which one or more embodiments of the present disclosure can be implemented. It would be appreciated that the electronic device 600 shown in FIG. 6 is only an example and should not constitute any restriction on the function and scope of the embodiments described herein. The electronic device 600 may be used, for example, to implement the TTS system 110 of FIG. 1. The electronic device 600 may also be used to implement the apparatus 500 of FIG. 5.

As shown in FIG. 6, the electronic device 600 is in the form of a general computing device. The components of the electronic device 600 may include, but are not limited to, one or more processing units or processors 610, a memory 620, a storage device 630, one or more communication units 640, one or more input devices 650, and one or more output devices 660. The processor 610 may be an actual or virtual processor and can execute various processes according to the programs stored in the memory 620. In a multiprocessor system, multiple processing units execute computer executable instructions in parallel to improve the parallel processing capability of the electronic device 600.

The electronic device 600 typically includes a variety of computer storage medium. Such medium may be any available medium that is accessible to the electronic device 600, including but not limited to volatile and non-volatile medium, removable and non-removable medium. The memory 620 may be volatile memory (for example, a register, cache, a random access memory (RAM)), a non-volatile memory (for example, a read-only memory (ROM), an electrically erasable programmable read-only memory (EEPROM), a flash memory) or any combination thereof. The storage device 630 may be any removable or non-removable medium, and may include a machine-readable medium, such as a flash drive, a disk, or any other medium, which can be used to store information and/or data (such as training data for training) and can be accessed within the electronic device 600.

The electronic device 600 may further include additional removable/non-removable, volatile/non-volatile, transitory/non-transitory storage medium. Although not shown in FIG. 6, a disk driver for reading from or writing to a removable, non-volatile disk (such as a “floppy disk”), and an optical disk driver for reading from or writing to a removable, non-volatile optical disk can be provided. In these cases, each driver may be connected to the bus (not shown) by one or more data medium interfaces. The memory 620 may include a computer program product 625, which has one or more program modules configured to perform various methods or acts of various embodiments of the present disclosure.

The communication unit 640 communicates with a further computing device through the communication medium. In addition, functions of components in the electronic device 600 may be implemented by a single computing cluster or multiple computing machines, which can communicate through a communication connection. Therefore, the electronic device 600 may be operated in a networking environment using a logical connection with one or more other servers, a network personal computer (PC), or another network node.

The input device 650 may be one or more input devices, such as a mouse, a keyboard, a trackball, etc. The output device 660 may be one or more output devices, such as a display, a speaker, a printer, etc. The electronic device 600 may also communicate with one or more external devices (not shown) through the communication unit 640 as required. The external device, such as a storage device, a display device, etc., communicate with one or more devices that enable users to interact with the electronic device 600, or communicate with any device (for example, a network card, a modem, etc.) that makes the electronic device 600 communicate with one or more other computing devices. Such communication may be executed via an input/output (I/O) interface (not shown).

According to example implementation of the present disclosure, a computer-readable storage medium is provided, on which a computer-executable instruction or computer program is stored, where the computer-executable instructions or the computer program is executed by the processor to implement the method described above. According to example implementation of the present disclosure, a computer program product is also provided. The computer program product is physically stored on a non-transient computer-readable medium and includes computer-executable instructions, which are executed by the processor to implement the method described above.

Various aspects of the present disclosure are described herein with reference to the flow chart and/or the block diagram of the method, the device, the equipment and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, special computers or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions includes a product, which includes instructions to implement various aspects of the functions/acts specified in one or more blocks in the flowchart and/or the block diagram.

The computer-readable program instructions may be loaded onto a computer, other programmable data processing apparatus, or other devices, so that a series of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is example, not exhaustive, and is not limited to the disclosed implementations. Without departing from the scope and spirit of the described implementations, many modifications and changes are obvious to ordinary skill in the art. The selection of terms used in this article aims to best explain the principles, practical application or improvement of technology in the market of each implementation, or to enable other ordinary skill in the art to understand the various embodiments disclosed herein.

What is claimed is:

1. A method of speech generation, comprising:
determining, based on a target text, a plurality of phoneme feature representations corresponding to a sequence of phonemes in the target text and respective phoneme durations for the plurality of phoneme feature representations;
extending the plurality of phoneme feature representations based on the respective phoneme durations, to obtain an extended sequence of phoneme feature representations;
masking at least one phoneme feature representation in the extended sequence of phoneme feature representations, to obtain a sequence of masked phoneme feature representations; and
generating a target speech corresponding to the target text at least based on the sequence of masked phoneme feature representations.

2. The method of claim 1, wherein extending the plurality of phoneme feature representations, to obtain the extended sequence of phoneme feature representations comprises:
for a phoneme feature representation in the plurality of phoneme feature representations,
repeating the phoneme feature representation based on the number of repetitions indicated by a phoneme duration corresponding to the phoneme feature representation; and
concatenating respective repeated phoneme feature representations for the plurality of phoneme feature representations in an order of the plurality of phoneme feature representations, to obtain the extended sequence of phoneme feature representations.

3. The method of claim 2, wherein masking the at least one phoneme feature representation in the extended sequence of phoneme feature representations comprises:
for a phoneme feature representation in the plurality of phoneme feature representations,
masking one or more of repeated phoneme feature representations for the phoneme feature representation in the extended sequence of phoneme feature representations, to retain one of the repeated phoneme feature representations for the phoneme feature representation.

4. The method of claim 1, wherein generating the target speech further comprises:
extracting an acoustic prompt feature representation from a prompt speech of a target speaker; and
generating the target speech based on the sequence of masked phoneme feature representations and the acoustic prompt feature representation.

5. The method of claim 4, wherein generating the target speech based on the sequence of masked phoneme feature representations and the acoustic prompt feature representation comprises:
generating a first intermediate speech feature representation without condition information;
generating a second intermediate speech feature representation with a condition of the plurality of phoneme feature representations;
generating a third intermediate speech feature representation with a condition of the plurality of phoneme feature representations and a condition of the acoustic prompt feature representation of the prompt feature; and
determining the target speech based on the first intermediate speech feature representation, the second intermediate speech feature representation and the third intermediate speech feature representation.

6. The method of claim 1, wherein the target speech is generated at least based on the sequence of masked phoneme feature representations using a trained diffusion model, and wherein the diffusion model is trained at least by:
determining, using a language model, a plurality of sample phoneme feature representations corresponding to a sequence of sample phonemes in a sample text and respective sample phoneme durations for the plurality of sample phoneme feature representations based on the sample text and a first sample speech;
determining, using a trained acoustic encoder, a first speech feature representation based on the first sample speech;
extending the plurality of sample phoneme feature representations based on the respective sample phoneme durations, to obtain an extended sequence of sample phoneme feature representations;
masking at least one phoneme feature representation in the extended sequence of sample phoneme feature representations, to obtain a sequence of masked sample phoneme feature representations;
determining, using the diffusion model under training, a reconstructed speech feature representation based on the sequence of masked sample phoneme feature representations and the first speech feature representation;
generating, using a trained acoustic decoder, a reconstructed speech for the first sample speech based on the reconstructed speech feature representation; and
training the diffusion model based on a difference between the first sample speech and the reconstructed speech.

7. The method of claim 6, wherein the diffusion model is further trained by:
obtaining training samples with a plurality of conditions, the plurality of conditions at least comprising a first condition indicating the plurality of sample phoneme feature representations and a second condition indicating the first sample speech;
selecting a first sub-training sample from the training samples with the second condition being dropped;
selecting a second sub-training sample from the first sub training sample with the first condition being dropped;
determining a third sub-training sample by removing the first sub training sample from the training samples; and
training the diffusion model based on the first sub-training sample, the second sub-training sample and the third sub-training sample.

8. The method of claim 6, wherein the diffusion model is trained by piecewise rectified flow acceleration.

9. The method of claim 6, wherein the acoustic encoder and the acoustic decoder are trained by:
determining, using the acoustic encoder under training, a second speech feature representation based on a second sample speech;
generating, using the acoustic decoder under training, a reconstructed acoustic wave based on the second speech feature representation; and
training the acoustic encoder and the acoustic decoder based on a difference between the reconstructed acoustic wave and an acoustic wave corresponding to the second sample speech.

10. An electronic device, comprising:
at least one processor; and
at least one memory coupled to the at least one processor and storing instructions executable by the at least one processor, the instructions, upon execution by the at least one processor, causing the electronic device to perform operations comprising:
determining, based on a target text, a plurality of phoneme feature representations corresponding to a sequence of phonemes in the target text and respective phoneme durations for the plurality of phoneme feature representations;
extending the plurality of phoneme feature representations based on the respective phoneme durations, to obtain an extended sequence of phoneme feature representations;
masking at least one phoneme feature representation in the extended sequence of phoneme feature representations, to obtain a sequence of masked phoneme feature representations; and
generating a target speech corresponding to the target text at least based on the sequence of masked phoneme feature representations.

11. The electronic device of claim 10, wherein extending the plurality of phoneme feature representations, to obtain the extended sequence of phoneme feature representations comprises:
for a phoneme feature representation in the plurality of phoneme feature representations,
repeating the phoneme feature representation based on the number of repetitions indicated by a phoneme duration corresponding to the phoneme feature representation; and
concatenating respective repeated phoneme feature representations for the plurality of phoneme feature representations in an order of the plurality of phoneme feature representations, to obtain the extended sequence of phoneme feature representations.

12. The electronic device of claim 11, wherein masking the at least one phoneme feature representation in the extended sequence of phoneme feature representations comprises:
for a phoneme feature representation in the plurality of phoneme feature representations,
masking one or more of repeated phoneme feature representations for the phoneme feature representation in the extended sequence of phoneme feature representations, to retain one of the repeated phoneme feature representations for the phoneme feature representation.

13. The electronic device of claim 10, wherein generating the target speech further comprises:
extracting an acoustic prompt feature representation from a prompt speech of a target speaker; and
generating the target speech based on the sequence of masked phoneme feature representations and the acoustic prompt feature representation.

14. The electronic device of claim 13, wherein generating the target speech based on the sequence of masked phoneme feature representations and the acoustic prompt feature representation comprises:
generating a first intermediate speech feature representation without condition information;
generating a second intermediate speech feature representation with a condition of the plurality of phoneme feature representations;
generating a third intermediate speech feature representation with a condition of the plurality of phoneme feature representations and a condition of the acoustic prompt feature representation of the prompt feature; and
determining the target speech based on the first intermediate speech feature representation, the second intermediate speech feature representation and the third intermediate speech feature representation.

15. The electronic device of claim 10, wherein the target speech is generated at least based on the sequence of masked phoneme feature representations using a trained diffusion model, and wherein the diffusion model is trained at least by:
determining, using a language model, a plurality of sample phoneme feature representations corresponding to a sequence of sample phonemes in a sample text and respective sample phoneme durations for the plurality of sample phoneme feature representations based on the sample text and a first sample speech;
determining, using a trained acoustic encoder, a first speech feature representation based on the first sample speech;
extending the plurality of sample phoneme feature representations based on the respective sample phoneme durations, to obtain an extended sequence of sample phoneme feature representations;
masking at least one phoneme feature representation in the extended sequence of sample phoneme feature representations, to obtain a sequence of masked sample phoneme feature representations;
determining, using the diffusion model under training, a reconstructed speech feature representation based on the sequence of masked sample phoneme feature representations and the first speech feature representation;
generating, using a trained acoustic decoder, a reconstructed speech for the first sample speech based on the reconstructed speech feature representation; and
training the diffusion model based on a difference between the first sample speech and the reconstructed speech.

16. The electronic device of claim 15, wherein the diffusion model is further trained by:
obtaining training samples with a plurality of conditions, the plurality of conditions at least comprising a first condition indicating the plurality of sample phoneme feature representations and a second condition indicating the first sample speech;
selecting a first sub-training sample from the training samples with the second condition being dropped;
selecting a second sub-training sample from the first sub training sample with the first condition being dropped;
determining a third sub-training sample by removing the first sub training sample from the training samples; and
training the diffusion model based on the first sub-training sample, the second sub-training sample and the third sub-training sample.

17. The electronic device of claim 15, wherein the diffusion model is trained by piecewise rectified flow acceleration.

18. The electronic device of claim 15, wherein the acoustic encoder and the acoustic decoder are trained by:
determining, using the acoustic encoder under training, a second speech feature representation based on a second sample speech;
generating, using the acoustic decoder under training, a reconstructed acoustic wave based on the second speech feature representation; and
training the acoustic encoder and the acoustic decoder based on a difference between the reconstructed acoustic wave and an acoustic wave corresponding to the second sample speech.

19. A non-transitory computer readable storage medium having computer executable instructions stored thereon, the computer executable instructions, when executed by an electronic device, causing the electronic device perform operations comprising:
determining, based on a target text, a plurality of phoneme feature representations corresponding to a sequence of phonemes in the target text and respective phoneme durations for the plurality of phoneme feature representations;
extending the plurality of phoneme feature representations based on the respective phoneme durations, to obtain an extended sequence of phoneme feature representations;
masking at least one phoneme feature representation in the extended sequence of phoneme feature representations, to obtain a sequence of masked phoneme feature representations; and
generating a target speech corresponding to the target text at least based on the sequence of masked phoneme feature representations.

20. The non-transitory computer readable storage medium of claim 19, wherein extending the plurality of phoneme feature representations, to obtain the extended sequence of phoneme feature representations comprises:
for a phoneme feature representation in the plurality of phoneme feature representations,
repeating the phoneme feature representation based on the number of repetitions indicated by a phoneme duration corresponding to the phoneme feature representation; and
concatenating respective repeated phoneme feature representations for the plurality of phoneme feature representations in an order of the plurality of phoneme feature representations, to obtain the extended sequence of phoneme feature representations.
